(19) United States
(12) Patent Application Publication
(10) Pub. No.: US 2005/0206155 A1
(43) Pub. Date: Sep. 22, 2005

(54) CD menu and song order control system

(76) Inventor: Robert Frank Porreca, Huntington Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/803,430

(22) Filed: Mar. 17, 2004

(51) Int. Cl. B42D 3/00

(52) U.S. Cl. 281/31

(57) ABSTRACT

A menu provides a plurality of transparent pockets mounted on the inner surface of the menu, each of the pockets adapted for receiving therein a printed insert. A plurality of the printed inserts are inserted into the pockets for convenient review by a user. Each printed insert provides the information of a song album title and a list of song titles corresponding to the song album title, or at least one artist name with, for each of the artist names, a song title corresponding to the artist. A software program receives user inputted song information and, therefrom, generates the printed inserts onto a sheet of cardstock which is perforated for producing the printed inserts for fitting into a jewel case or into the pockets of the menu.

### INCORPORATION BY REFERENCE

Applicant(s) hereby incorporate herein by reference, any and all U. S. patents and U.S. patent applications cited or referred to in this application.

### BACKGROUND OF THE INVENTION

1. Field of the Invention

This invention relates generally to printed materials used with song media for understanding what is recorded on a CD ROM, the order of recording; and more particularly to a menu system and means for generating such a menu for improved convenience in controlling the order of play of songs on one or more CD ROMs.

2. Description of Related Art

The following art defines the present state of this field:

Temple et al., U.S. Pat. No. 5,396,987 describes a container for compact discs comprising a lightweight sleeve formed of three thin sheets of polypropylene material that are die cut and heat bonded together. A front pocket has a deep U-shaped notch formed on its outer face and provides for insertion of a Compact Disc (CD). A back pocket is provided for a printed CD package insert. On both the front surface and the back surface, a pocket is formed at the top of the container to receive a narrow, information-bearing strip, such as the title bar from a jewel box.

Montoya et al., U.S. Pat. No. 5,949,688 describes a compact disc (“CD”) vending system that allows a purchaser to compile a series of desired tracks, and correctly write these to a compact disc. The invention also enables the customer to customize the jacket or surface of the compact disc with a desired slogan or graphic. Included are an ordering computer, a viewing computer, a keyboard, a payment slot that can take either cash, credit or debit cards, a data source, a CD recording unit, and a printing unit that can print words or graphics on the surface of CDs and their sleeves. The data source unit contains the information to be recorded onto the surface of a CD. The viewing computer will provide access to available titles, so that the user can watch and listen to them before making a selection. The ordering computer enables the user to place his or her order by entering its title or catalog number and any other information that may be required for the production of the CD. The ordering computer has a hard drive or other storage device containing information on available selections. In the first embodiment of the invention, the data source is an internal high capacity data storage system, containing files with all available selections. In the second embodiment of the invention, the data source is a CD jukebox. In the third embodiment of the invention, an outside host system contains the data source, which is accessed using a high speed modem.

Dockes et al., U.S. Pat. No. 5,959,944 describes a system and method for production of customized compact discs on demand including acquisition means for acquiring audio data from a plurality of commercial-quality CDs and converting the audio data to digital format; mass storage means, coupled to the acquisition means, for storing the audio data in digital format; indexing means for associating identification data uniquely attributable to the plurality of commercial-quality CDs with their respective audio data in digital format; order processing means for compiling customer data including particularized selection data and shipping data; writing means for recording the customer data to a blank CD; packaging means for labeling the blank CD recorded by the writing means and inserting same in a box for shipment; and production management means, coupled to the mass storage means, indexing means, order processing means, writing means, and packaging means, for controlling production of the customized CDs.

Schoen et al., U.S. Pat. No. 5,592,511 describes a system for creation of user-selected customized audio products, defined as a plurality of songs from different recording artists recorded on a single compact disc (CD) or digital audio tape (DAT) cassette, at record store/distributor locations utilizing a digitized, central database with production hardware at distributor sites. Customized products consist of CD ROM or digital audiotapes (DAT) with music or voice content selected from large digital database, and are written at local workstations at distribution centers (such as record stores), which are connected by a high-speed communications network. The system records costs of the digitized audio (e.g., royalties for individual songs) for billing purposes, as well as producing descriptive material (contents, background information, and graphics for labels, etc.). Data transfer and production is faster than real-time, and thus will be a significant improvement and will tend to reduce current analog hardware-to-hardware transfer (“pirating”) which violate copyright laws and is unauthorized. The system consists of integrated, state-of-the-art digital databases, communications networks, computer workstations, and unique workstation processing software, and provides an innovative product/service (individual customized albums or audio data compilations), which currently do not exist.

Miller, U.S. Pat. No. 5,595,293 describes a CD wallet with an entrapped graphics sheet and dedicated to the storing of a particular CD corresponding to the graphics on the entrapped graphics sheet, together with a method for fabricating the dedicated CD wallet. The wallet is fabricated of flexible panels of thermoplastic sheet material, and the entrapped graphics sheet includes two parallel scores thereon and is preferably of greater rigidity than the plastic panels, permitting the plastic panels to bend along the scores on the entrapped graphics sheet to form a spine when the graphics sheet is folded along the scores.

Palmer et al., U.S. Pat. No. 5,996,785 describes storage of storage media, a sleeve having one or two storage pocket formed between an optional substrate and two cover plates. The sleeves in turn may be mounted on a spine having a plurality of vertebrae connected by flexible hinges. The sleeves mount on respective vertebrae by slidable insertion of mounting slots onto mounting tracks. The flexible hinges then permit easy user access to and review of the storage media contents of individual sleeves in an intuitive roll-and-tumble manner. The sleeves and the spine may in turn also be stored in a clamshell style case or a wallet style case, or loose sleeves may be stored in a tray.

Sapienza et al., U.S. Pat. No. 6,511,246 describes an indexing system with a label display configured for connection to a stack holder for placement adjacent a stack of sheets held in the stack holder. The display has a label portion disposed in a viewing position beyond the stack and is configured for displaying label indicia thereon for identifying a section of the stack. A divider is configured for dividing the section of the stack from other sections and for mounting in the stack holder within the stack. A tab connected to the divider and positionable extending beyond the stack and over the label portion is configured to permit viewing of the indicia therethrough with the divider held in the stack holder. An indexing system package and a system for displaying indexing system packages is also disclosed.

Combs, U.S. Pat. No. 6,571,945 describes a CD-ROM holder, which is formed from two sheets of heat-fusable material, such as vinyl. The CD-ROM and a backer card, which is preferably a substantially square sheet of cardboard with a width and height substantially equal to the diameter of the CD-ROM, are placed between the two sheets of vinyl and these sheets are thermally fused on all four edges in order to completely contain the CD-ROM and backer card. A perforated double tear line is preferably provided along one edge of one of the sheets of vinyl in order to provide an easily opened channel through which the CD-ROM may be accessed. Furthermore, at least one of the vinyl sheets preferably includes indicia and/or graphic markings thereon in order to provide a message to the recipient of the CD-ROM holder. Additional indicia and/or graphics may be printed onto one or both sides of the backer card. One side of the backer card opposite the CD-ROM is preferably completely visible through the clear vinyl side opposite the CD-ROM.

Gotlieb, WO99/05049 describes A package for a compact disc and a booklet of lyrics. The package comprises an outer container and an inner sleeve with the inner sleeve being divided into two compartments, one for the compact disc and a separate compartment for the booklet. The inner sleeve is capable of being received within the outer container in either of two positions, one for long-term storage and a second for short-term storage, the latter providing easier access to the compact disc. A disc holding mechanism holds the disc in the inner sleeve.

Our prior art search with abstracts described above teaches: containers for CDs, a compact disc recorder and vending machine, a system and method for the production of customized compact discs on demand, a digital customized audio product with user created data and associated distribution and production system, a wallet for containing a CD and fabrication method, a detachable module and flat object storage system, an indexing system package and display system, a vinyl CD-ROM holder, a fold formed CD jacket and method, and a package for CDs, but does not teach an information card creation and use system that enables the creation of custom playback series. The present invention fulfills these needs and provides further related advantages as described in the following summary.

### SUMMARY OF THE INVENTION

The present invention teaches certain benefits in construction and use which give rise to the objectives described below.

The present invention is a menu designed for programming a multi-disc, 3-12 compact disc player. When the user loads their multi-disc player, they will also load the menu with corresponding printed title cards previously printed and stored in their CD cases. The title cards are placed in pockets whose numbers correspond to the positions in the cartridge or carousel of the CD player. This enables the user to select a song or artist in a manner similar to a juke box. Each card preferably measures about 12 mm allowing it to be inserted into a jewel case. If the album information is made available on line, for instance, the printed insert cards would be able to be printed by downloading the information rather then typing it from a keyboard. The invention overcomes the problem that currently exists in that once CDs are inserted into a player, it is difficult to know which songs of which albums are on which tracks. One certainly may refer to the printed lists that accompany information about each CD, but this is inconvenient and difficult. The present menu system overcomes this difficulty in presenting all of the titles on a single sheet for easy and convenient selection and play.

A menu provides a plurality of transparent numbered pockets mounted on the inner surface of the menu, each of the pockets adapted for receiving therein a printed insert. A plurality of the printed inserts are inserted into the pockets for convenient review by a user. Each printed insert provides the information of a song album title and a list of song titles corresponding to the song album title, or at least one artist name with, for each of the artist names, a song title corresponding to the artist. A software program receives user inputted song information and, therefrom, generates the printed inserts onto a sheet of cardstock which is perforated for producing the printed inserts for fitting into a jewel case or into the pockets of the menu.

A primary objective of the present invention is to provide an apparatus and method of use of such apparatus that yields advantages not taught by the prior art.

Another objective is to provide such an invention capable of enabling an audiophile to arrange song playback in an audio system in a preferred sequence.

A further objective is to provide such an invention capable of identifying the titles on a CD while the CD is playing.

A still further objective is to provide such an invention capable of printing song information on inserts for a jewel case or for pockets in a menu.

A still further objective is to provide the convenience of preparing a printed insert for a menu whereby songs on a custom made CD are listed and easily located in a CD player.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a menu folder with pockets for printed inserts;

FIG. 2 is a plan view of one of the printed inserts in a first format;

FIG. 3 is a plan view of another one of the printed inserts in a second format;

FIG. 4 is a logic flow diagram of a program used to generate the printed inserts; and

FIG. 5 is a plan view of a printed cardstock sheet perforated for tearing into individual printed inserts.

### DETAILED DESCRIPTION OF THE INVENTION

The above described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

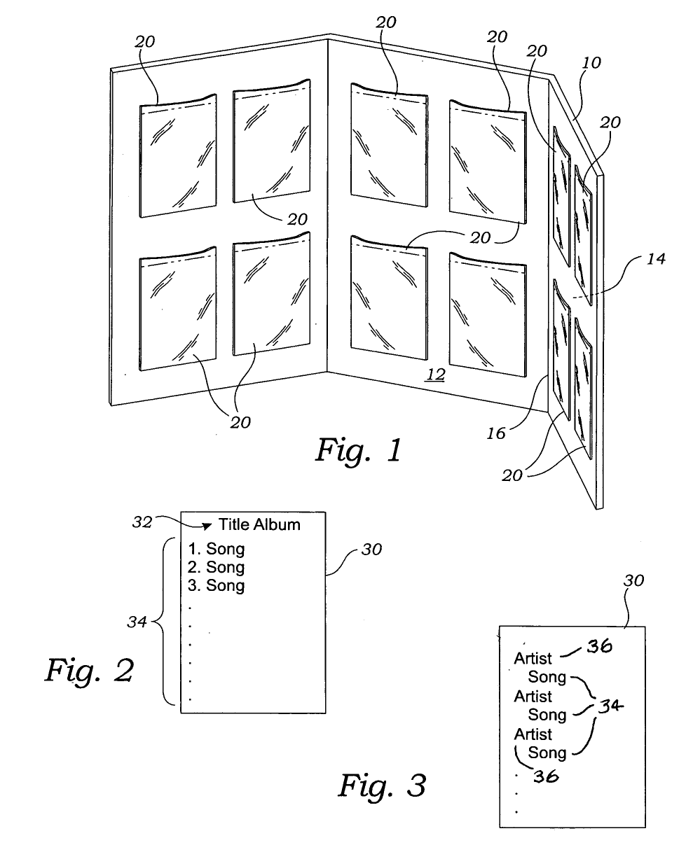

The present invention is an apparatus comprising a paper, cardboard or plastic menu 10, as shown in FIG. 1, having an inner surface 12 and an opposing outer surface 14, the menu 10 is enabled by creases 16 for folding to enclose the inner surface 12 within the outer surface 14 for compact storage of the folder 10. A plurality of transparent pockets 20, preferably of a plastic sheet stock, are mounted, by sewing, by adhesive bonding or equivalent methods, on the inner surface 12, and each of the pockets 20 is adapted for receiving therein a printed insert 30 so that the printed inserts 30 is able to be read when the menu 10 is open. Each of the printed inserts 30 is printed in one of two ways: with a commercial song album title 32, and a list of song titles 34 that are a part of the album; see FIG. 2, or with a list of artist's names 36 and for each of the artist's names, one song title 34 by that artist; see FIG. 3. In addition to the menu 10, the present invention includes a software program 40 provided on a storage media, such as a compact disk, that is able to be executed on a desk or laptop computer, etc. This software program 40 enables the generation of the printed inserts 30.

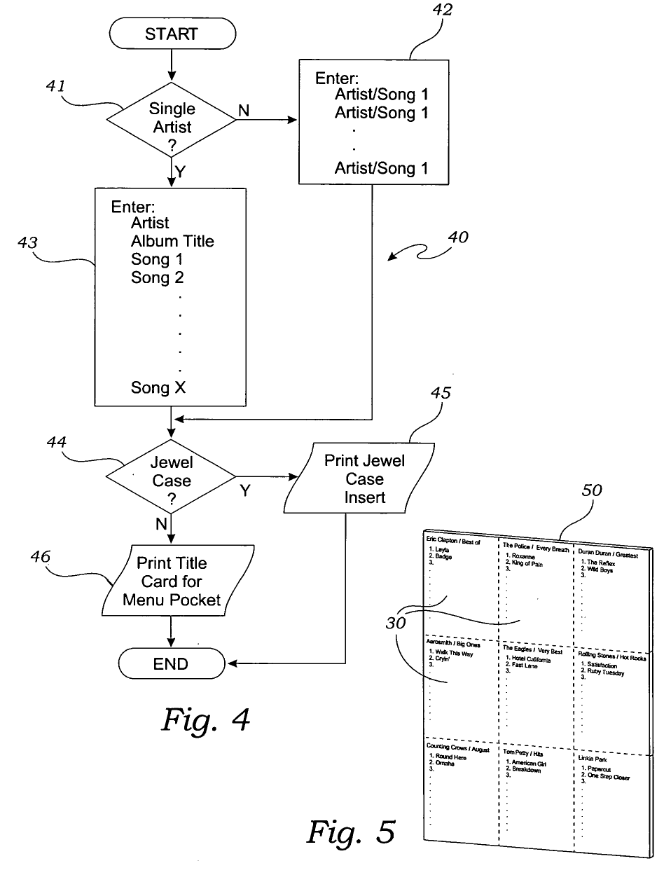

The software program 40, as shown in FIG. 4, comprises steps, interactive with a user, which enable the printing of the printed inserts 30. In a first interactive step, a user selects either a single artist or a plurality of artists (element 41), typically as selected by a pointing device such as a mouse on a computer monitor display of choices. Next, the program 40 requests inputting of information, typically as entered by the user from a keyboard. The inputted information is either a list of song artist's names and for each, a related song (element 42) or an album title, related artist(s) name, and related song titles (element 43). Finally, the program 40 presents a choice (element 44) between printing the information as an insert for a jewel case (element 45) or as an insert for one of the pockets 20 of the menu 10 (element 46). If a jewel case insert is printed, it is of a size that secured and held within a compact CD case, a standard CD case or a DVD case by simple placement therein and has printed on it, the album information or artist/song information. In this instance, the printed inserts 30 may be easily referred to when the corresponding album is played, so that the user knows which songs are on each track and is more conveniently able to make selections of songs during play. The production of such a software program 40, for displaying choices for selection by a user on a computer display monitor, for receiving typed information and for printing a preselected formatted layout of such information onto card stock in a standard printer, is considered to be within the range of capability of an ordinary computer program writer, so that FIG. 4 meets the requirements of 35 USC 112 in enabling the preparation and use of the present invention.

Clearly, the invention may preferably include at least one letter size card stock sheet perforated for tearing into a plurality of the printed inserts after the sheet is printed. The menu 10 with its pockets 20, the software program 40 and plural of the card stock sheets 50 may be commercially offered as a kit for the user to prepare and use the invention to advantage to fill a need in the marketplace.

The enablements described in detail above are considered novel over the prior art of record and are considered critical to the operation of the instant invention and to the achievement of the above described objectives. The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. An apparatus comprising: a menu having an inner surface and an opposing outer surface; a plurality of transparent pockets mounted on the inner surface of the menu, each of the pockets adapted for receiving therein a printed insert; and a plurality of the printed inserts for insertion into the pockets, each said printed insert printed with one of:
a) a song album title and a list of song titles corresponding to the song album title, and
b) at least one artist name with, for each of the artist names, a song title corresponding to the artist;
and, a software program enabled for receiving user inputted song information and, therefrom, generating the printed inserts.

2. The apparatus of claim 1 wherein the software program comprises the interactive steps of: selecting one of a single artist and plural artists; receiving information including at least one of: at least one artist name, at least one album title, and at least one song title; and selecting and printing the printed inserts for fitting into one of a jewel case and the pockets.

3. The apparatus of claim 1 wherein the folder is enabled for folding to enclose the inner surface within the outer surface for compact storage of the folder.

4. An apparatus comprising in combination as a kit: a menu having an inner surface and an opposing outer surface; a plurality of transparent pockets mounted on the inner surface of the menu, each of the pockets adapted for receiving therein a printed insert; and a plurality of the printed inserts for insertion into the pockets, each said printed insert printed with one of:
a) a song album title and a list of song titles corresponding to the song album title, and
b) at least one artist name with, for each of the artist names, a song title corresponding to the artist;
at least one letter size card stock sheet perforated for tearing into a plurality of the printed inserts after the sheet is printed; and
a software program enabled for receiving user inputted song information and, therefrom, printing the information onto the sheet for generating the printed inserts.

5. The apparatus of claim 4 wherein the software program comprises the interactive steps of: selecting one of a single artist and plural artists; receiving information including at least one of: at least one artist name, at least one album title, and at least one song title; and selecting and printing the printed inserts for fitting into one of a jewel case and the pockets.

6. The apparatus of claim 4 wherein the folder is enabled for folding to enclose the inner surface within the outer surface for compact storage of the-folder.
